(19) United States
(12) Patent Application Publication
(10) Pub. No.: US 2024/0208519 A1
(43) Pub. Date: Jun. 27, 2024

(54) AUTONOMOUS VEHICLE ENERGY EFFICIENCY USING DEEP LEARNING ADAPTIVE SENSING

(71) Applicants: Hyundai Motor Company, Seoul (KR); Kia Corporation, Seoul (KR)

(72) Inventors: Bilal Javaid, Westland, MI (US); Tuncer Yumak, Taylor, MI (US)

(21) Appl. No.: 18/086,924

(22) Filed: Dec. 22, 2022

(51) Int. Cl. B60W 50/06; B60W 10/30; B60W 60/00

(52) U.S. Cl. CPC B60W 50/06; B60W 10/30; B60W 60/001; B60W 2420/40; B60W 2420/42; B60W 2420/52; B60W 2530/10; B60W 2530/201; B60W 2554/4042; B60W 2710/305

(57) ABSTRACT

Systems and methods are provided for adjusting a sensing frequency for one or more sensors of an autonomous vehicle (AV) is provided. The method comprises determining one or more environmental factors of a current environment of an AV, using a neural network, determining, based on the one or more environmental factors, one or more actions for adjusting driving performance and energy consumption of the AV, wherein the one or more actions comprises adjusting a sensing frequency of one or more sensors coupled to the AV, and performing, using a computing device of the AV, the one or more actions, wherein the computing device comprises a processor and a memory.

### BACKGROUND

### Technical Field

Embodiments of the present disclosure relate to systems and methods for dynamically adjusting sensing frequencies in autonomous vehicles (AVs), based on environmental risks, in order to remove unnecessary computations, reducing energy usage.

### Background

Fully autonomous vehicles (AVs) rely on one or more sensors, coupled to the AVs, configured to acquire sensor data pertaining to the environment surrounding the AVs. This sensor data enables the AVs to more accurately plan trajectories to navigate the environments surrounding the AVs.

Due to the amount of data that can be acquired via these one or more sensors, AVs require large quantities of computing power in order to process sensor data and make a path plan. This significantly affects the energy efficiency of the AVs. Additionally, the number of sensors (e.g. microphones, infrared cameras, time-of-flight cameras, etc.) coupled to the AVs may continue to increase in future AVs. These additional sensors will further impact the computing power needed and further decrease AV power efficiency.

Since energy efficiency is an increasingly important factor in vehicle design, particularly with the current trend of switching to electric vehicles, partly due to energy efficiency, for mass market adoption, AVs need to be reasonably energy efficient. Therefore, for at least these reasons, systems and methods for enabling AVs to process sensor data while reducing energy consumption is needed.

### SUMMARY

According to an object of the present disclosure, a method for adjusting a sensing frequency for one or more sensors of an autonomous vehicle (AV) is provided. The method may comprise determining one or more environmental factors of a current environment of an AV, using a neural network, determining, based on the one or more environmental factors, one or more actions for adjusting driving performance and energy consumption of the AV, wherein the one or more actions comprises adjusting a sensing frequency of one or more sensors coupled to the AV, and performing, using a computing device of the AV, the one or more actions, wherein the computing device comprises a processor and a memory.

According to an exemplary embodiment of the present disclosure, the determining the one or more environmental factors may comprise receiving sensor data from the one or more sensors coupled to the AV.

According to an exemplary embodiment of the present disclosure, the one or more sensors may comprise one or more of: a LiDAR system; a radar system; a camera; a precipitation sensor; a light sensor; and a position sensor.

According to an exemplary embodiment of the present disclosure, the determining the one or more actions may comprise determining a risk level of the current environment, and the one or more actions may be based on the risk level of the current environment.

According to an exemplary embodiment of the present disclosure, the one or more actions may comprise adjusting a power mode for one or more of the one or more sensors.

According to an exemplary embodiment of the present disclosure, the method may further comprise, after performing the one or more actions, evaluating the driving performance and energy consumption of the AV.

According to an exemplary embodiment of the present disclosure, the one or more environmental factors may comprise one or more of: position or velocity data of one or more objects within the environment of the AV; radar data; LiDAR data; camera data; precipitation sensor data; light sensor data; position sensor data; a sun elevation angle; date information; one or more dimensions of the AV; and a vehicle weight of the AV.

According to an object of the present disclosure, a system for adjusting a sensing frequency for one or more sensors of an AV is provided. The system may comprise an autonomous vehicle, comprising one or more sensors and a computing device, comprising a processor and a memory, configured to determine one or more environmental factors of a current environment of an AV, using a neural network, determine, based on the one or more environmental factors, one or more actions for adjusting driving performance and energy consumption of the AV, wherein the one or more actions comprises adjusting a sensing frequency of the one or more sensors, and perform the one or more actions, wherein the computing device comprises a processor and a memory.

According to an exemplary embodiment of the present disclosure, the one or more sensors may be configured to transmit data, and the determining the one or more environmental factors may comprise receiving sensor data from the one or more sensors.

According to an exemplary embodiment of the present disclosure, the one or more sensors may comprise one or more of: a LiDAR system; a radar system; a camera; a precipitation sensor; a light sensor; and a position sensor.

According to an exemplary embodiment of the present disclosure, the determining the one or more actions may comprise determining a risk level of the current environment, and the one or more actions may be based on the risk level of the current environment.

According to an exemplary embodiment of the present disclosure, the one or more actions may comprise adjusting a power mode for one or more of the one or more sensors.

According to an exemplary embodiment of the present disclosure, the computing device may be further configured to, after performing the one or more actions, evaluate the driving performance and energy consumption of the AV.

According to an exemplary embodiment of the present disclosure, the one or more environmental factors may comprise one or more of: position or velocity data of one or more objects within the environment of the AV; radar data; LiDAR data; camera data; precipitation sensor data; light sensor data; position sensor data; a sun elevation angle; date information; one or more dimensions of the AV; and a vehicle weight of the AV.

According to an object of the present disclosure, a system for adjusting a sensing frequency for one or more sensors of an AV is provided. The system may comprise one or more sensors coupled to an AV, and a computing device, comprising a processor and a memory, coupled to the AV, configured to store programming instructions. The programming instructions, when executed by the processor, may be configured to cause the processor to determine one or more environmental factors of a current environment of an AV, using a neural network, determine, based on the one or more environmental factors, one or more actions for adjusting driving performance and energy consumption of the AV, wherein the one or more actions comprises adjusting a sensing frequency of the one or more sensors, and perform the one or more actions, wherein the computing device comprises a processor and a memory.

According to an exemplary embodiment of the present disclosure, the one or more sensors may be configured to transmit data, and the determining the one or more environmental factors may comprise receiving sensor data from the one or more sensors.

According to an exemplary embodiment of the present disclosure, the one or more sensors may comprise one or more of: a LiDAR system; a radar system; a camera; a precipitation sensor; a light sensor; and a position sensor.

According to an exemplary embodiment of the present disclosure, the determining the one or more actions may comprise determining a risk level of the current environment, and the one or more actions may be based on the risk level of the current environment.

According to an exemplary embodiment of the present disclosure, the one or more actions may comprise adjusting a power mode for one or more of the one or more sensors.

According to an exemplary embodiment of the present disclosure, the programming instructions may be further configured to cause the processor to, after performing the one or more actions, evaluate the driving performance and energy consumption of the AV.

According to an exemplary embodiment of the present disclosure, the one or more environmental factors may comprise one or more of: position or velocity data of one or more objects within the environment of the AV; radar data; LiDAR data; camera data; precipitation sensor data; light sensor data; position sensor data; a sun elevation angle; date information; one or more dimensions of the AV; and a vehicle weight of the AV.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates a method for adjusting a sensing frequency for one or more sensors of an autonomous vehicle (AV), according to an exemplary embodiment of the present disclosure;

FIG. 2 illustrates a method for determining a status of a current environment of an AV, according to an exemplary embodiment of the present disclosure;

FIG. 3 illustrates neural network architecture of a neural network, according to an exemplary embodiment of the present disclosure;

FIG. 4 illustrates example elements of a computing device, according to an exemplary embodiment of the present disclosure; and

FIG. 5 illustrates an example architecture of a vehicle, according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Hereinafter, some embodiments of the present disclosure will be described in detail with reference to the exemplary drawings. In the drawings, the same reference numerals will be used throughout to designate the same or equivalent elements. In addition, a detailed description of well-known features or functions will be ruled out in order not to unnecessarily obscure the gist of the present disclosure.

Autonomous vehicles (AVs) comprise one or more sensors, coupled to the AVs, configured to sense one or more aspects of an environment of the AVs. These sensors collect vast quantities of data. Processing this data requires computational power.

Computation resources are expected to be a significant portion of an AV's overall energy consumption. Full autonomy may require redundant systems. Redundant systems would, in turn, require double the computing power. The sampling rate of the one or more sensors significantly affects the power usage of one or more computing devices coupled to the AVs. Furthermore, each sensor itself uses more power when running using a high sampling rate. This effect propagates to other modules in the computing pipeline of the AV, such as perception and planning.

Additionally, a higher sampling rate may shorten the lifespan of sensors due to more usage. Some sensors have configurable power modes instead of sampling rates (e.g., GPS sensors may be configured to use online correction data or only use satellite signals).

According to an exemplary embodiment, systems and methods for dynamically adjusting sensing frequencies for AVs, based on environmental risks (e.g., a risk level), are provided in order to remove unnecessary computations and thus reduce the energy usage of the AVs, increasing AV energy efficiency.

By way of example, the environmental risk would be low for an AV in a rural environment with no other vehicles present. In such a scenario, running one or more sensors coupled to the AV at a highest frequency would be an unnecessary power usage.

By way of example, the environmental risk would be high for an AV in an urban environment with many other vehicles present and rainy weather. In such a scenario, running the one or more sensors coupled to the vehicle at a highest frequency would likely be a necessary power usage.

According to an exemplary embodiment, the systems and methods of the present disclosure may be configured to tune a sensing frequency of the one or more sensors based on environmental risks. According to an exemplary embodiment, since the relationship between optimal sensing frequency and AV environment is complex, the systems and methods of the present disclosure may be configured to use deep reinforcement learning in order to dynamically adjust the sensing frequencies.

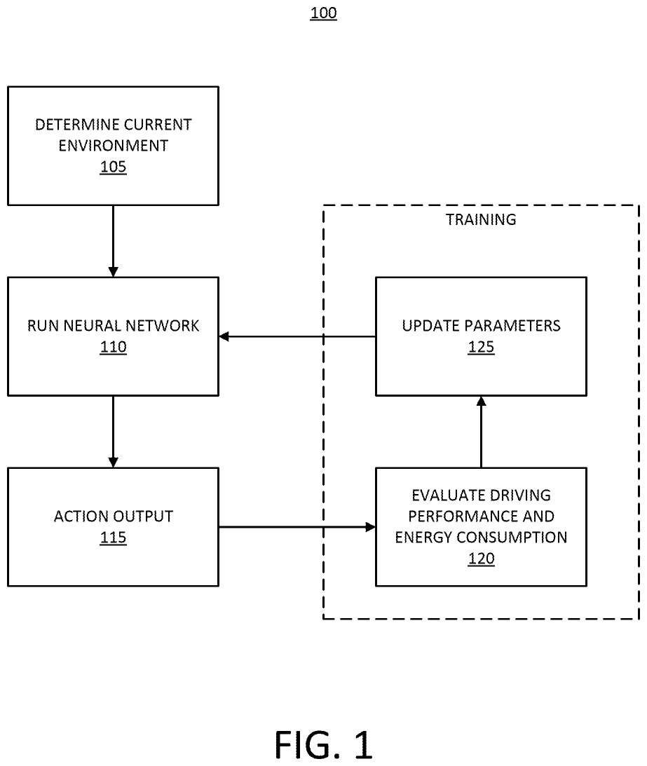

Referring now to FIG. 1, a method 100 for adjusting a sensing frequency for one or more sensors of an AV is illustratively depicted, in accordance with an exemplary embodiment of the present disclosure.

At 105, a status of a current environment of an AV is determined. According to an exemplary embodiment, the AV is configured to calculate one or more optimal sensing rates based on the current environment.

By way of example, in a rural environment with no traffic and good weather, an AV may have a clear view of the surrounding environment, there are no other vehicles which pose a risk, and the roadway ahead is clear. In this scenario, the AV may reduce power consumption by decreasing the sensing rate while maintaining enough of a rate for safety (e.g., in case an animal walks onto the roadway, the AV can still sense the animal in time to react). In this example, the AV may reduce the sensing rate from 100 Hz to 10 Hz (10× decrease). It is noted, however, that other sensing rate decreases and/or increases may occur, while maintaining the spirit and functionality of the present disclosure.

By way of example, in an urban environment with traffic and precipitation, an AV must anticipate sudden movements from the other vehicles, some regions of the environment may be occluded by objects and/or vehicles, and one or more sensors may not operate ideally in precipitation. In this scenario, the AV may maintain a high sensing rate in order to ensure safe operation.

A real driving environment may be somewhere between these 2 examples or may exceed the bounds of these examples. Therefore, it is beneficial to use a neural network in order to capture complex and non-linear relationships between the environment and optimal sensing rate.

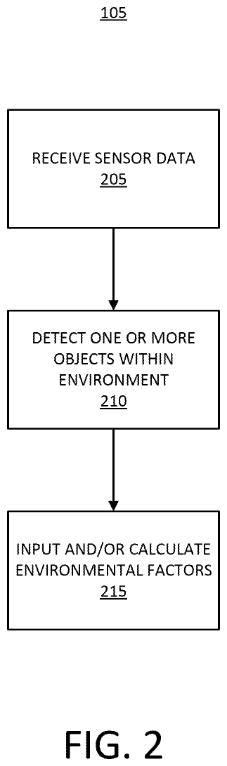

The method 105 of determining the status of the current environment of the AV is described, in more detail, in FIG. 2, according to an exemplary embodiment of the present disclosure.

According to an exemplary embodiment, as shown in FIG. 2, at 205, sensor data is received, from the one or more sensors coupled to the AV, by one or more computing devices coupled to the AV. According to an exemplary embodiment, the current environment may be represented in a way that captures key factors relevant to the sensing rate but is not excessive such that it results in the neural network being too big.

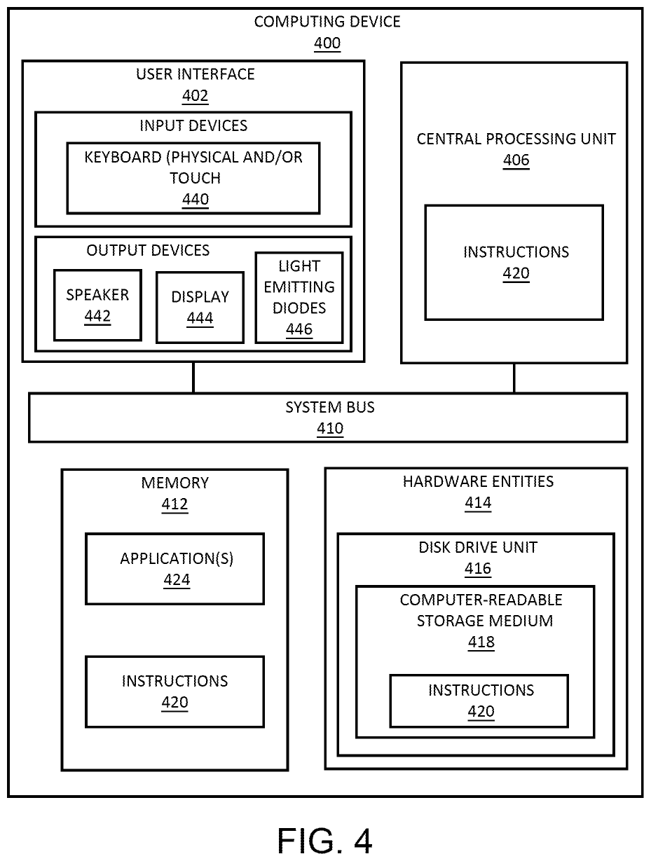

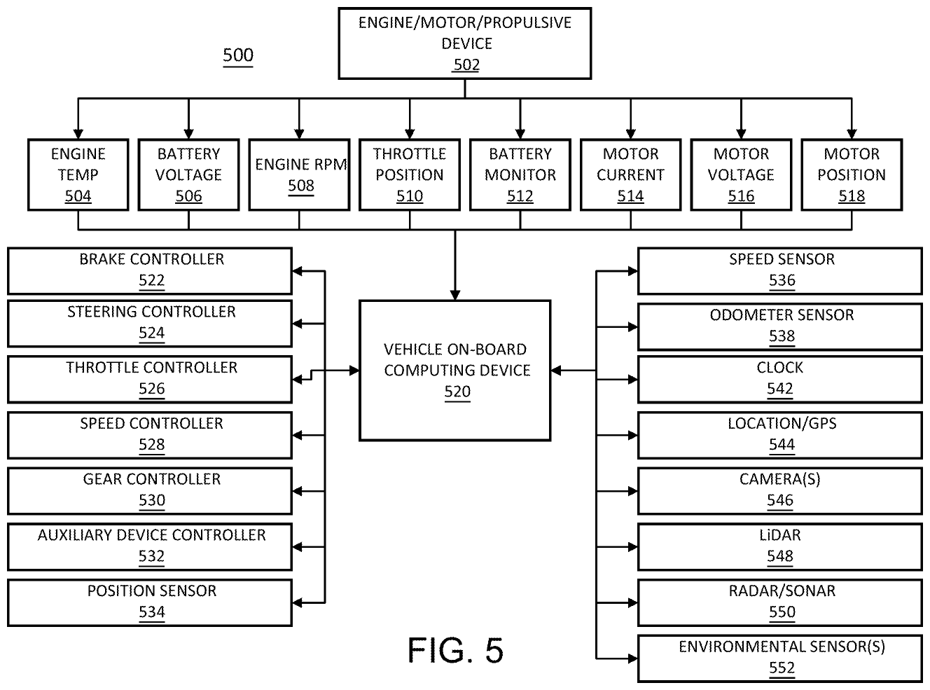

According to an exemplary embodiment, the sensor data used in order to determine the current environment may comprise data from a predetermined set of sensors. The predetermined set of sensors may comprise one or more radar sensors, one or more LiDAR sensors, one or more cameras, one or more precipitation sensors, one or more light sensors, one or more position sensors (e.g., one or more global positioning system (GPS) sensors and/or other suitable position sensors), and/or one or more other suitable sensors. The predetermined set of sensors may be configured to transmit data to a computing device of the AV. According to an exemplary embodiment, the AV may comprise one or more computing devices (e.g., computing device 400 of FIG. 4, computing device 520 of FIG. 5), one or more power consumption sensors, and/or one or more other suitable components. According to an exemplary embodiment, the computing device may be configured to control a sampling rate of one or more of the one or more sensors, and/or may comprise a neural network accelerator.

At 210, one or more objects within the environment of the AV are detected using data returned from the one or more sensors coupled to the AV. Objects may be, e.g., pedestrians, vehicles, animals, plants, rocks, debris, and/or one or more other suitable objects within the environment of the AV.

Objects may be detected using one or more suitable means such as, e.g., detecting and isolating objects using LiDAR detection, radar detection, camera imagery, and/or other suitable means such as, e.g, known methods in the industry. According to an exemplary embodiment, the computing device (e.g., computing device 400 of FIG. 4, computing device 520 of FIG. 5), may be configured to isolate and/or identify one or more objects within the environment based on size, shape, movement, opacity, color, texture, and/or one or more other suitable physical characteristics.

Detecting the one or more objects may comprise determining a relative location, velocity, and/or trajectory of the one or more objects. According to an exemplary embodiment, the more objects present within the environment of the vehicle, the more risk.

At 215, one or more environmental factors are calculated and/or input into the one or more computing devices of the AV. The one or more environmental factors may comprise information pertaining to the one or more objects within the environment of the AV, raw radar data, raw LiDAR data, camera data, precipitation sensor data, light sensor data, position sensor data, the sun elevation angle, the day of the year (date information), one or more dimensions of the AV, the vehicle weight of the AV, and/or one or more other suitable environmental factors.

According to an exemplary embodiment, the location, velocity, trajectory, and/or other suitable factors of the one or more object (e.g., vehicles, pedestrians, etc.) may increase and/or decrease risk. E.g., approaching vehicles or nearby pedestrians may present a higher risk and thus warrant a higher sensing rate.

The one or more LiDAR sensors may be configured to generate a 3-dimensional (3D) point cloud. According to an exemplary embodiment, the LiDAR 3D point cloud may be filtered, down sampled, and/or simplified in a way to reduce the size of the LiDAR 3D point cloud of the neural network.

According to an exemplary embodiment, the ground area of the environment of the AV may be estimated from the LiDAR 3D point cloud, and thus, from the LiDAR 3D point cloud, the AV can know how much area is occluded by other objects.

The LiDAR 3D point cloud is a good indicator of an amount of an occluded area within the environment of the AV. More occlusion generally represents more uncertainty and risk.

The one or more precipitation sensors may be configured to determine the presence or absence of precipitation within the environment of the AV. The presence of precipitation generally represents more risk.

The one or more light sensors may be configured to determine a light factor of one or more regions of the environment of the AV, indicating one or more regions of the environment of the AV that are lit and/or dark. According to an exemplary embodiment, the one or more light sensors may be configured to determine a brightness level of one or more regions of the environment of the vehicle. According to an exemplary embodiment, dark regions of the environment of the AV generally represent more risk.

According to an exemplary embodiment, the one or more position sensors may be configured to generate position data (e.g., global navigation satellite system (GNSS) coordinates) pertaining to the geographic location of the AV. According to an exemplary embodiment, increased and/or decreased risk may be associated with particular geographic locations. E.g., some geographic locations may accompany a higher risk of deer crossings.

The sun elevation angle represents the angle of the sun in relation to the AV. According to an exemplary embodiment, increased and/or decreased risk for a particular location may be associated with the cycle of the day (e.g., the position of the sun in relation to the AV). E.g., for a particular location, more deer activity and therefore higher risk may occur during dusk and dawn.

According to an exemplary embodiment, the day of the year may be indicative of an increase and/or decrease in risk for a particular location. E.g., for a particular location, there may be more deer activity, and therefore more risk, in autumn.

According to an exemplary embodiment, the dimensions of the AV (e.g., length, width, height, shape, etc.) may be indicative of increased and/or decreased risk. E.g., increased vehicle size may be associated with a greater risk.

According to an exemplary embodiment, the weight of the AV may be indicative of increased and/or decreased risk. Vehicles with greater vehicle weight require longer braking distances and may present more risk.

According to an exemplary embodiment, one or more values of the environmental factors may be scaled and/or shifted in order to normalize inputs to the neural network.

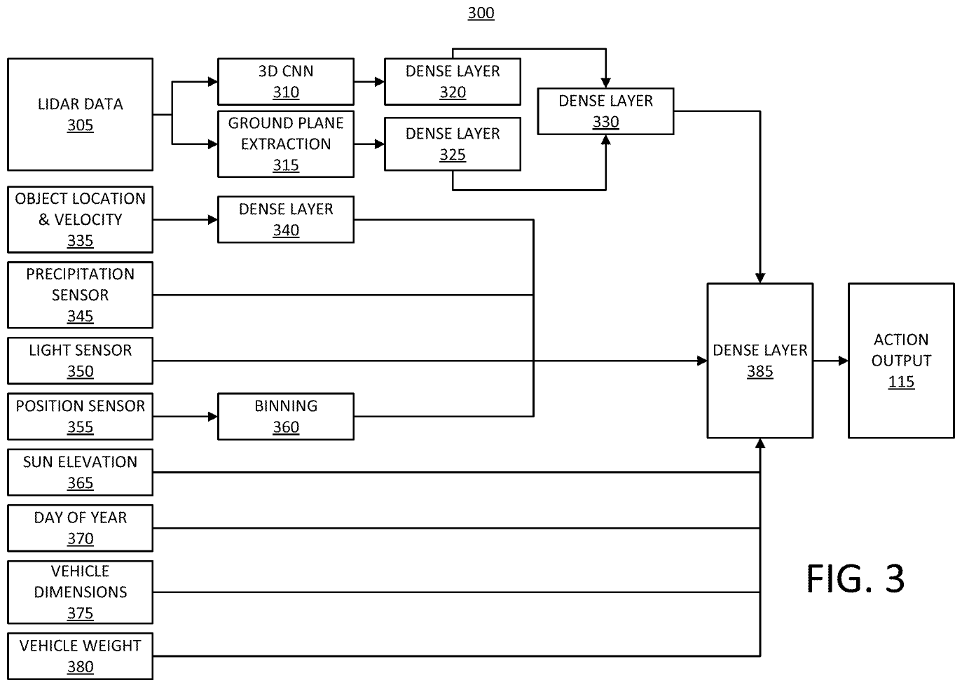

At 110, this status of the current environment is sent to a neural network, which is run in order to determine an optimal sampling rate of one or more of the one or more sensors. Neural network architecture 300 of the neural network is shown in FIG. 3, in accordance with an exemplary embodiment of the present disclosure.

According to an exemplary embodiment, one or more environmental factors are input into the neural network. The one or more environmental factors may comprise, but are not limited to, the LiDAR data 305, the location and/or velocity data 335 for one or more objects, the light sensor data 350, the position sensor data 355, the sun elevation 365, the day of the year 370, the vehicle dimensions 375 of the AV, the vehicle weight 380 of the AV, and/or one or more other suitable environmental factors.

According to an exemplary embodiment, the 3D point cloud from the LiDAR data 305 may be input into a convolutional neural network (CNN) 310 configured to extract feature data from the 3D point cloud. The extracted features may be passed to a dense layer 320. According to an exemplary embodiment, the 3D point cloud from the LiDAR data 305 may be input into a ground plane extraction module 315 configured to extract ground plane information from the 3D point cloud, which then may be input into a dense layer 325. The 3D CNN data and the ground plane extraction data may then be condensed at dense layer 350.

According to an exemplary embodiment, the location and velocity data 335 of the one or more objects may be condensed at dense layer 340.

According to an exemplary embodiment, the position sensor data 355 may be binned 360.

According to an exemplary embodiment, all of the sensor data may be condensed in one or more dense layers 385. This condensed data may then be analyzed in order to generate an action output 115 (as also shown in FIG. 1).

It is noted that the layers shown and described in FIG. 3 are examples and greater or fewer layers may be incorporated into the architecture of the neural network, while maintaining the spirit and functionality of the present disclosure.

According to an exemplary embodiment, the action output 115 of the neural network may be an optimal action for the AV to take in order to achieve a lowest power consumption while maintaining safe operation. The action output may comprise incrementing and/or decrementing a sensing frequency and/or sampling rate for each sensor controllable by the AV. It is noted, however, that other suitable actions of the action output may be incorporated, while maintaining the spirit and functionality of the present disclosure. According to an exemplary embodiment, for some sensors, the sampling rate may not be relevant, but a configurable power mode may be controlled by the AV according to the action output 115. For example, a localization module may be configured to disable differential corrections for GNSS and only use satellite signals for positioning. By way of example, the localization module may be configured to disable map matching to a high definition map in order to reduce power consumption. By further way of example, the AV may be configured to control the update rate of a path planning module, configured to plan a path of the AV.

According to an exemplary embodiment, each sensor and/or otherwise controllable points by the AV may be configured to be individually tuned by the neural network, enabling flexibility in finding the optimal setting or settings. For example, the AV may determine that certain environments need cameras but do not need radar and LiDAR sensors. In this case, the AV many be configured to maintain a high camera sensor rate but decrease or shutdown the one or more radar and LiDAR sensors.

At 120, the driving performance and energy consumption of the AV is evaluated during a training function.

According to an exemplary embodiment, the AV may be configured to continuously monitor the driving performance and energy consumption in order to evaluate the success of the action output, at 115, generated by the neural network, at 110.

According to an exemplary embodiment, the energy consumption may be directly measured using current and/or voltage sensors. According to an exemplary embodiment, the evaluation, at 120, may be used to calculate updated parameters of the neural network, thus creating a feedback loop. The parameters, at 125, may be updated according to the generated updated parameters. The updated parameters may then be input into the neural network which can then be run again, at 110.

The end result of the training feedback loop is the minimization of energy consumption and maximizing driving performance. According to an exemplary embodiment, the algorithm for quantifying driving performance and energy consumption is designed to penalize undesirable driving events (e.g., collisions, hard braking, etc.) and reward energy savings. The system may have a tendency to decrease the sensor rate as much as possible in order to save energy. However, if sensor rate is decreased too much, the expected outcome may be that the AV will make sudden movements due to late detection of road objects (e.g., vehicles, pedestrians, etc.). These sudden movements may be penalized by the reward function and thus create feedback that balances the sensor rate.

According to an exemplary embodiment of the present disclosure, the training of the system may start in a simulation environment. The reason being that the system may need to experience many training examples in order to develop to a reasonable model that works during real-world applications.

According to an exemplary embodiment, the training may comprise many collisions while the AV is learning a reasonable model. After sufficient simulation training, the system may be trained on real-world scenarios in order to fine-tune the model to account for real-world details that cannot be captured in simulations.

After vehicle production, the system may be configured to continue to be trained using data feedback from a vehicle fleet, wherein each vehicle in the vehicle fleet may be configured to utilize adaptive sensing methods and may be configured to transmit data to a cloud storage (e.g., using 4G LTE). According to an exemplary embodiment, the system may distinguish based on region, so that all vehicles in a particular region may be configured to share data and model updates.

While AVs have been described through this disclosure, it is noted that other types of vehicles may be incorporated, such as, e.g., vehicles in which a driver is in control, but is being assisted by autonomous features.

Referring now to FIG. 4, an illustration of an example architecture for a computing device 400 is provided. According to an exemplary embodiment, one or more functions of the present disclosure may be implemented by a computing device such as, e.g., computing device 400 or a computing device similar to computing device 400.

The hardware architecture of FIG. 4 represents one example implementation of a representative computing device configured to perform one or more methods and means for adjusting a sensing frequency for one or more sensors of an AV, as described herein. As such, the computing device 400 of FIG. 4 implements at least a portion of the method(s) described herein (e.g., method 100 of FIG. 1).

Some or all components of the computing device 400 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 4, the computing device 400 may comprise a user interface 402, a Central Processing Unit (“CPU”) 406, a system bus 410, a memory 412 connected to and accessible by other portions of computing device 400 through system bus 410, and hardware entities 414 connected to system bus 410. The user interface may comprise input devices and output devices, which may be configured to facilitate user-software interactions for controlling operations of the computing device 400. The input devices may comprise, but are not limited to, a physical and/or touch keyboard 450. The input devices may be connected to the computing device 400 via a wired or wireless connection (e.g., a Bluetooth® connection). The output devices may comprise, but are not limited to, a speaker 452, a display 454, and/or light emitting diodes 456.

At least some of the hardware entities 414 may be configured to perform actions involving access to and use of memory 412, which may be a Random Access Memory (RAM), a disk driver and/or a Compact Disc Read Only Memory (CD-ROM), among other suitable memory types. Hardware entities 414 may comprise a disk drive unit 416 comprising a computer-readable storage medium 418 on which may be stored one or more sets of instructions 420 (e.g., programming instructions such as, but not limited to, software code) configured to implement one or more of the methodologies, procedures, or functions described herein. The instructions 420 may also reside, completely or at least partially, within the memory 412 and/or within the CPU 406 during execution thereof by the computing device 400.

The memory 412 and the CPU 406 may also constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 420 for execution by the computing device 400 and that cause the computing device 400 to perform any one or more of the methodologies of the present disclosure.

Referring now to FIG. 5, an example vehicle system architecture 500 for a vehicle (e.g., an AV, as described above) is provided, in accordance with an exemplary embodiment of the present disclosure.

As shown in FIG. 5, the vehicle system architecture 500 may comprise an engine, motor or propulsive device (e.g., a thruster) 502 and various sensors 504-518 for measuring various parameters of the vehicle system architecture 500. In gas-powered or hybrid vehicles having a fuel-powered engine, the sensors 504-518 may comprise, for example, an engine temperature sensor 504, a battery voltage sensor 506, an engine Rotations Per Minute (RPM) sensor 508, and/or a throttle position sensor 510. If the vehicle is an electric or hybrid vehicle, then the vehicle may comprise an electric motor, and accordingly may comprise sensors such as a battery monitoring system 512 (to measure current, voltage and/or temperature of the battery), motor current 514 and voltage 516 sensors, and motor position sensors such as resolvers and encoders 518.

Operational parameter sensors that are common to both types of vehicles may comprise, for example: a position sensor 534 such as an accelerometer, gyroscope and/or inertial measurement unit; a speed sensor 536; and/or an odometer sensor 538. The vehicle system architecture 500 also may comprise a clock 542 that the system uses to determine vehicle time and/or date during operation. The clock 542 may be encoded into the vehicle on-board computing device 520, it may be a separate device, or multiple clocks may be available.

The vehicle system architecture 500 also may comprise various sensors that operate to gather information about the environment in which the vehicle is traveling. These sensors may comprise, for example: a location sensor 544 (for example, a Global Positioning System (GPS) device); object detection sensors such as one or more cameras 546, a LIDAR sensor system 548; and/or a RADAR and/or a sonar system 550. The sensors also may comprise environmental sensors 552 such as, e.g., a humidity sensor, a precipitation sensor, a light sensor, and/or ambient temperature sensor. The object detection sensors may be configured to enable the vehicle system architecture 500 to detect objects that are within a given distance range of the vehicle in any direction, while the environmental sensors 552 may be configured to collect data about environmental conditions within the vehicle's area of travel.

During operations, information may be communicated from the sensors to an on-board computing device 520 (e.g., computing device 400 of FIG. 4). The on-board computing device 520 may be configured to analyze the data captured by the sensors and/or data received from data providers and may be configured to optionally control operations of the vehicle system architecture 500 based on results of the analysis. For example, the on-board computing device 520 may be configured to control: braking via a brake controller 522; direction via a steering controller 524; speed and acceleration via a throttle controller 526 (in a gas-powered vehicle) or a motor speed controller 528 (such as a current level controller in an electric vehicle); a differential gear controller 530 (in vehicles with transmissions); and/or other controllers.

Geographic location information may be communicated from the location sensor 544 to the on-board computing device 520, which may then access a map of the environment that corresponds to the location information to determine known fixed features of the environment such as streets, buildings, stop signs and/or stop/go signals. Captured images from the cameras 546 and/or object detection information captured from sensors such as LIDAR 548 may be communicated from those sensors to the on-board computing device 520. The object detection information and/or captured images may be processed by the on-board computing device 520 to detect objects in proximity to the vehicle. Any known or to be known technique for making an object detection based on sensor data and/or captured images may be used in the embodiments disclosed in this document.

The above description is merely illustrative of the technical spirit of the present disclosure, and those skilled in the art to which the present disclosure belongs may make various modifications and changes without departing from the essential features of the present disclosure.

Although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Thus, the embodiments disclosed in the present disclosure are not intended to limit the technology spirit of the present disclosure, but are intended to describe the present disclosure, and the scope of the technical spirit of the present disclosure is not limited by these embodiments. The scope of protection of the present disclosure should be interpreted by the appended claims, and all technical spirits within the scope equivalent thereto should be interpreted as being included in the scope of the present disclosure.

What is claimed is:

1. A method for adjusting a sensing frequency for one or more sensors of an autonomous vehicle (AV), comprising:
determining one or more environmental factors of a current environment of an AV;
using a neural network, determining, based on the one or more environmental factors, one or more actions for adjusting driving performance and energy consumption of the AV,
wherein the one or more actions comprises adjusting a sensing frequency of one or more sensors coupled to the AV; and
performing, using a computing device of the AV, the one or more actions,
wherein the computing device comprises a processor and a memory.

2. The method of claim 1, wherein the determining the one or more environmental factors comprises:
receiving sensor data from the one or more sensors coupled to the AV.

3. The method of claim 2, wherein the one or more sensors comprise one or more of:
a LiDAR system;
a radar system;
a camera;
a precipitation sensor;
a light sensor; and
a position sensor.

4. The method of claim 1, wherein:
the determining the one or more actions comprises determining a risk level of the current environment, and
the one or more actions are based on the risk level of the current environment.

5. The method of claim 1, wherein the one or more actions comprises adjusting a power mode for one or more of the one or more sensors.

6. The method of claim 1, further comprising, after performing the one or more actions, evaluating the driving performance and energy consumption of the AV.

7. The method of claim 1, wherein the one or more environmental factors comprise one or more of:
position or velocity data of one or more objects within the environment of the AV;
radar data;
LiDAR data;
camera data;
precipitation sensor data;
light sensor data;
position sensor data;
a sun elevation angle;
date information;
one or more dimensions of the AV; and
a vehicle weight of the AV.

8. A system for adjusting a sensing frequency for one or more sensors of an autonomous vehicle (AV), comprising:
an autonomous vehicle, comprising:
one or more sensors; and
a computing device, comprising a processor and a memory, configured to:
determine one or more environmental factors of a current environment of an AV;
using a neural network, determine, based on the one or more environmental factors, one or more actions for adjusting driving performance and energy consumption of the AV,
wherein the one or more actions comprises adjusting a sensing frequency of the one or more sensors; and
perform the one or more actions,
wherein the computing device comprises a processor and a memory.

9. The system of claim 8, wherein:
the one or more sensors are configured to transmit data, and
the determining the one or more environmental factors comprises receiving sensor data from the one or more sensors.

10. The system of claim 9, wherein the one or more sensors comprise one or more of:
a LIDAR system;
a radar system;
a camera;
a precipitation sensor;
a light sensor; and
a position sensor.

11. The system of claim 8, wherein:
the determining the one or more actions comprises determining a risk level of the current environment, and
the one or more actions are based on the risk level of the current environment.

12. The system of claim 8, wherein the one or more actions comprises adjusting a power mode for one or more of the one or more sensors.

13. The system of claim 8, wherein the computing device is further configured to:
after performing the one or more actions, evaluate the driving performance and energy consumption of the AV.

14. The system of claim 8, wherein the one or more environmental factors comprise one or more of:
position or velocity data of one or more objects within the environment of the AV;
radar data;
LiDAR data;
camera data;
precipitation sensor data;
light sensor data;
position sensor data;
a sun elevation angle;
date information;
one or more dimensions of the AV; and
a vehicle weight of the AV.

15. A system for adjusting a sensing frequency for one or more sensors of an autonomous vehicle (AV), comprising:
one or more sensors coupled to an AV; and
a computing device, comprising a processor and a memory, coupled to the AV, configured to store programming instructions that, when executed by the processor, cause the processor to:
determine one or more environmental factors of a current environment of an AV;
using a neural network, determine, based on the one or more environmental factors, one or more actions for adjusting driving performance and energy consumption of the AV,
wherein the one or more actions comprises adjusting a sensing frequency of the one or more sensors; and
perform the one or more actions,
wherein the computing device comprises a processor and a memory.

16. The system of claim 15, wherein:
the one or more sensors are configured to transmit data, and
the determining the one or more environmental factors comprises receiving sensor data from the one or more sensors.

17. The system of claim 16, wherein the one or more sensors comprise one or more of:
a LiDAR system;
a radar system;
a camera;
a precipitation sensor;
a light sensor; and
a position sensor.

18. The system of claim 15, wherein:
the determining the one or more actions comprises determining a risk level of the current environment, and
the one or more actions are based on the risk level of the current environment.

19. The system of claim 15, wherein the one or more actions comprises adjusting a power mode for one or more of the one or more sensors.

20. The system of claim 8, wherein the programming instructions are further configured to cause the processor to:
after performing the one or more actions, evaluate the driving performance and energy consumption of the AV.
